(19) United States
(12) Patent Application Publication
(10) Pub. No.: US 2013/0314932 A1
(43) Pub. Date: Nov. 28, 2013

(54) FLEXIBLE MOTORCYCLE TURN SIGNAL SYSTEM AND APPARATUS

(71) Applicants: Scott Taylor, San Martin, CA (US); Todd Anderson, Morgan Hill, CA (US)

(72) Inventors: Scott Taylor, San Martin, CA (US); Todd Anderson, Morgan Hill, CA (US)

(21) Appl. No.: 13/626,089

(22) Filed: Sep. 25, 2012

Related U.S. Application Data
(60) Provisional application No. 61/539,347, filed on Sep. 26, 2011.

(51) Int. Cl. F21S 8/10

(52) U.S. Cl. CPC F21S 48/212
USPC 362/473

(57) ABSTRACT

A flexible vehicle signal light includes a turn signal mount, a light source and a flexible stalk including a flexible, coiled like, external spring, a flexible tube insert disposed inside the flexible, coiled like, external spring, a first end of the flexible stalk secured to the turn signal mount and a second end of the flexible stalk secured to the light source.

### CROSS REFERENCE TO RELATED APPLICATIONS

This application claims priority from U.S. Provisional Patent Application No. 61/539,347 filed on Sep. 26, 2011 and entitled “Flexible Motorcycle Turn Signal,” which is incorporated herein by reference in its entirety for all purposes.

### BACKGROUND

The present invention relates generally to motor vehicle signaling systems, and more particularly, to methods and systems for external turn signal light systems.

Typical motorcycle turn signals consist of a light fixture mounted on a rigid stalk. The rigid stalk is rigidly fixed to each side of the motorcycle, protruding outward from the motorcycle.

A typical motorcycle is a narrow, single track vehicle. Thus the typical motorcycle turn signals protrude out each side of the motorcycle and are subject to being broken and/or sheared off if the motorcycle tips on its side or passes a fixed object too closely. As a result, the rigid stalk of the typical motorcycle turn signal can be sheared off from the side of the motorcycle. The light fixture portion of the typical motorcycle turn signal can be crushed, broken or sheared off the rigid stalk of the typical motorcycle turn signal.

In view of the foregoing, there is a need for a flexible motorcycle turn signal that can resist damage from typical motorcycle tip-over and from passing fixed objects too closely.

### SUMMARY

Broadly speaking, the present invention fills these needs by providing a flexible turn signal. It should be appreciated that the present invention can be implemented in numerous ways, including as a process, an apparatus, a system, computer readable media, or a device. Several inventive embodiments of the present invention are described below.

One embodiment provides a flexible vehicle signal light includes a turn signal mount, a light source and a flexible stalk including a flexible, coiled like, external spring, a flexible tube insert disposed inside the flexible, coiled like, external spring, a first end of the flexible stalk secured to the turn signal mount and a second end of the flexible stalk secured to the light source.

At least one of the first end of the flexible stalk or the second end of the flexible stalk can be secured inside a respective counter bore portion of the respective light source and the turn signal mount. At least a portion of the respective counter bore portion of the respective light source and the turn signal mount can be filled with an adhesive fill material including covering at least one coil of the flexible, coiled like, external spring with the adhesive fill material.

At least a portion of the respective counter bore portion of the respective light source and the turn signal mount can be compressed inward to have an inner diameter sufficient to compress an outer diameter of the flexible, coiled like, external spring within the respective counter bore portion. The respective counter bore portion of the respective light source and the turn signal mount can include a threaded portion and a threaded sleeve capable of threading into the respective counter bore portion and capturing a respective first end or second end of the flexible stalk in the counter bore portion.

At least one of the first end of the flexible stalk or the second end of the flexible stalk can be secured to a corresponding outer diameter portion of the respective light source and the turn signal mount. A clamping band can be disposed over one or more coils of the flexible, coiled like, external spring, the clamping band providing a clamping pressure on the one or more coils to clamp the one or more coils to the corresponding outer diameter portion of the respective light source and the turn signal mount. One or more grooves corresponding to one or more coils of the flexible, coiled like, external spring can be included in the corresponding outer diameter portion of the respective light source and the turn signal mount. At least one of the first end of the flexible stalk or the second end of the flexible stalk can be secured to a corresponding outer diameter portion of the respective light source and the turn signal mount with an adhesive fill material.

The flexible tube insert can have an outer diameter substantially equal to an inner diameter of the flexible, coiled like, external spring. The light source can include one or more light emitting diodes. The flexible stalk can also include an inner passage extending through the turn signal mount, an inner central portion of the flexible stalk and into the light source. Multiple electrical conductors can be included having a first end coupled to the light source and a second end extending beyond the turn signal mount. The electrical conductors can be disposed within an inner central portion of the flexible stalk. The electrical conductors can be disposed within the flexible tube insert.

Another embodiment provides a flexible vehicle signal light including a turn signal mount, a light source, a flexible stalk including a flexible, coiled like, external spring, a flexible tube insert disposed inside the flexible, coiled like, external spring, a first end of the flexible stalk secured to the turn signal mount and a second end of the flexible stalk secured to the light source, the flexible stalk further includes an inner passage extending through the turn signal mount, an inner central portion of the flexible stalk and into the light source, multiple electrical conductors having a first end coupled to the light source and a second end extending beyond the turn signal mount, the plurality of electrical conductors passing through the inner passage and at least one of the first end of the flexible stalk or the second end of the flexible stalk are secured inside a respective counter bore portion of the respective light source and the turn signal mount, wherein at least a portion of the respective counter bore portion of the respective light source and the turn signal mount is filled with an adhesive fill material including covering at least one coil of the flexible, coiled like, external spring with the adhesive fill material.

Yet another embodiment provides a flexible vehicle signal light including a turn signal mount, a light source and a flexible stalk including a flexible, coiled like, external spring, a flexible tube insert disposed inside the flexible, coiled like, external spring, a first end of the flexible stalk secured to the turn signal mount, a second end of the flexible stalk secured to the light source and wherein at least one of the first end of the flexible stalk or the second end of the flexible stalk are secured inside a respective counter bore portion of the respective light source and the turn signal mount, wherein at least a portion of the respective counter bore portion of the respective light source and the turn signal mount is compressed inward to have an inner diameter sufficient to compress an outer diameter of the flexible, coiled like, external spring within the respective counter bore portion.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 is a schematic diagram of a flexible turn signal, in accordance with one embodiment of the present invention.

FIG. 2A is a top view of the flexible turn signal, in accordance with one embodiment of the present invention.

FIG. 2B is a frontal view of the flexible turn signal, in accordance with one embodiment of the present invention.

FIG. 3A is a detailed cutaway view of the first end of the flexible shaft, in accordance with one embodiment of the present invention.

FIG. 3B is a detailed cutaway view of the second end of the flexible shaft, in accordance with one embodiment of the present invention.

FIG. 4 is a side view of the flexible turn signal, in accordance with one embodiment of the present invention.

### DETAILED DESCRIPTION

Several exemplary embodiments for flexible motorcycle turn signal systems will now be described. It will be apparent to those skilled in the art that the present invention may be practiced without some or all of the specific details set forth herein.

The flexible turn signal can include a turn signal light fixture coupled to a flexible shaft. The flexible shaft is capable of flexing greater than about 90 degrees from a centered, resting position, and greater than about 180 degrees from maximum deflection, and return to the centered, rest position without any permanent deformation.

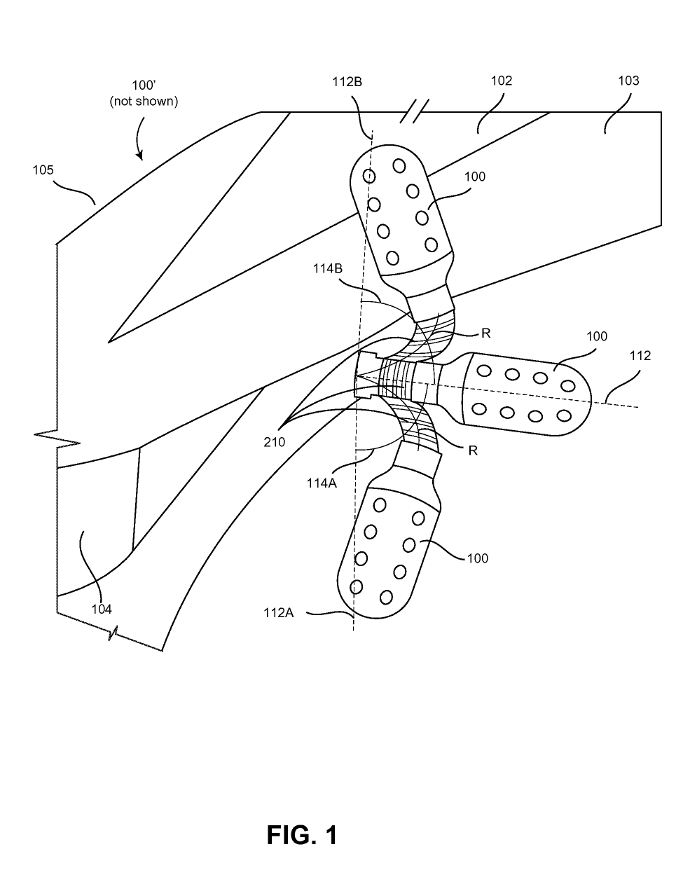

FIG. 1 is a schematic diagram of a flexible turn signal 100, in accordance with one embodiment of the present invention. The flexible turn signal 100 is mounted on a first side 103 of a motorcycle rear fender 102. A second flexible turn signal 100′ (not shown) is mounted on a second side 105 of a motorcycle rear fender 102, opposite from the first side 103. A tail light 104 is also mounted on the motorcycle rear fender 102.

The flexible stalk 210 is capable of flexing to a first flexed position 112A greater than about 90 degrees in a first angle 114A in a first direction, from a centered, resting position, denoted by a center line 112. The flexible stalk 210 is also capable of flexing to a second flexed position 112B greater than about 90 degrees in a second angle 114B in a second direction, substantially opposite from the first direction, from the centered, resting position 112. Thus providing greater than about 180 degrees from maximum deflection between the first flexed position 112A and the second flexed position 112B. The flexible stalk 210 flexes along a substantially smooth radius R where the flexing is distributed along the length of the flexible stalk 210.

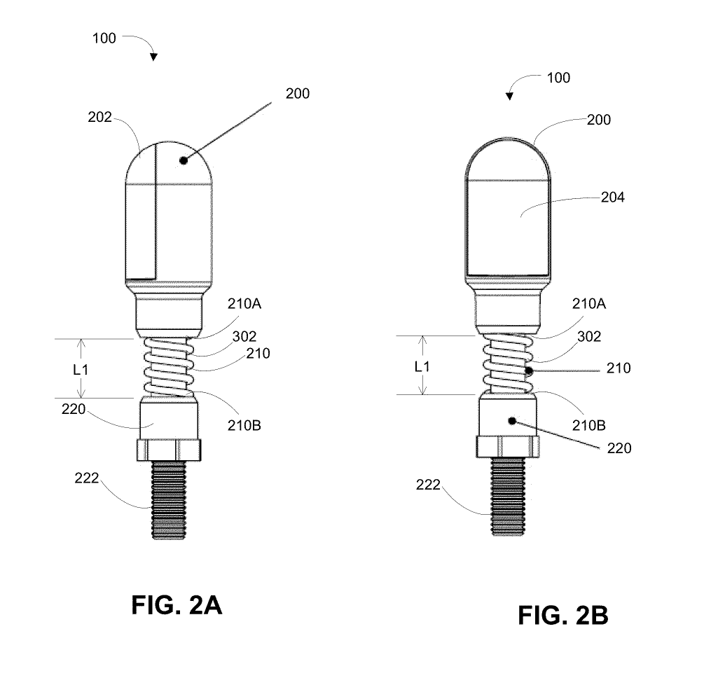

FIG. 2A is a top view of the flexible turn signal 100, in accordance with one embodiment of the present invention. FIG. 2B is a frontal view of the flexible turn signal 100, in accordance with one embodiment of the present invention. The flexible turn signal 100 includes a housing 200. The housing 200 can be a substantially rigid structure formed from any suitable material ranging from a metal (e.g., zinc, nickel steel, aluminum, titanium, copper and alloys and combinations thereof) to a plastic (e.g., polystyrene, polyethylene, PTFE, ABS, PVC, polycarbonate, polyester resin, fiberglass composite, carbon fiber composite, etc.) or a flexible material (e.g., rubber, urethane, etc.).

The housing 200 includes a lens 202 and encloses a light source 204. The light source 204 can include one or more individual light sources. By way of example, the light source 204 can include a single light bulb or one or more light emitting diodes (LEDs) mounted in a suitable socket. The light source 204 can include multiple light bulbs or one or more LEDs mounted on a circuit board.

The housing 200 also provides an anchoring structure for a first end 210A of a flexible stalk 210. A second end 210B of the flexible stalk 210 is secured to a turn signal mount 220. The turn signal mount 220 can include one or more shaft portions 222. The one or more shaft portions 222 can be threaded for mounting to the mounting point on a motorcycle.

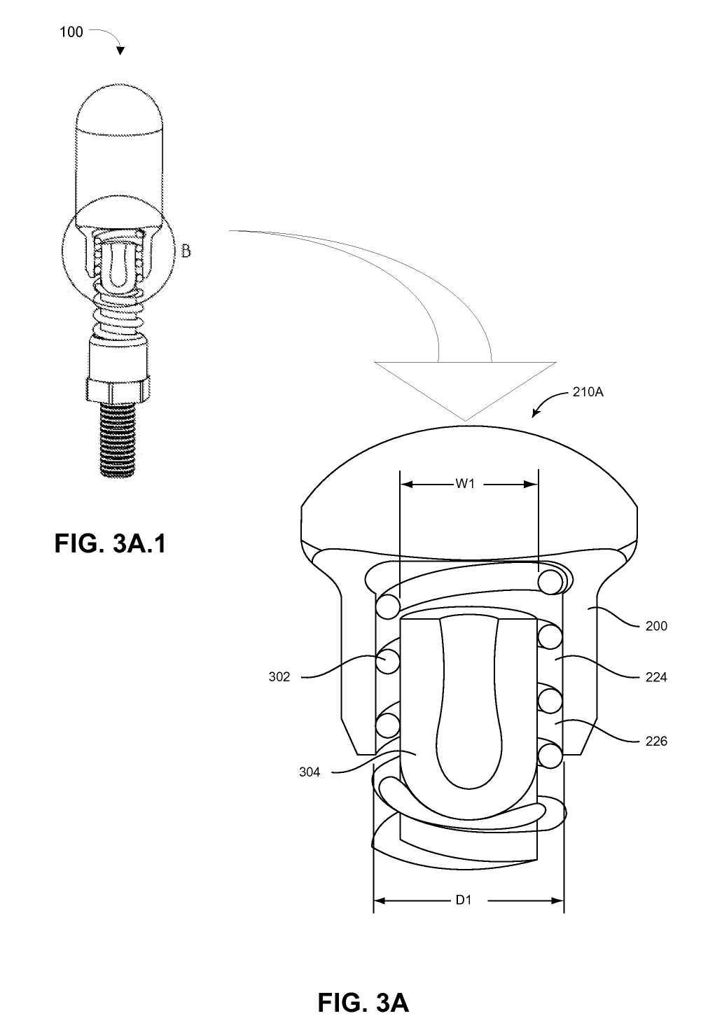

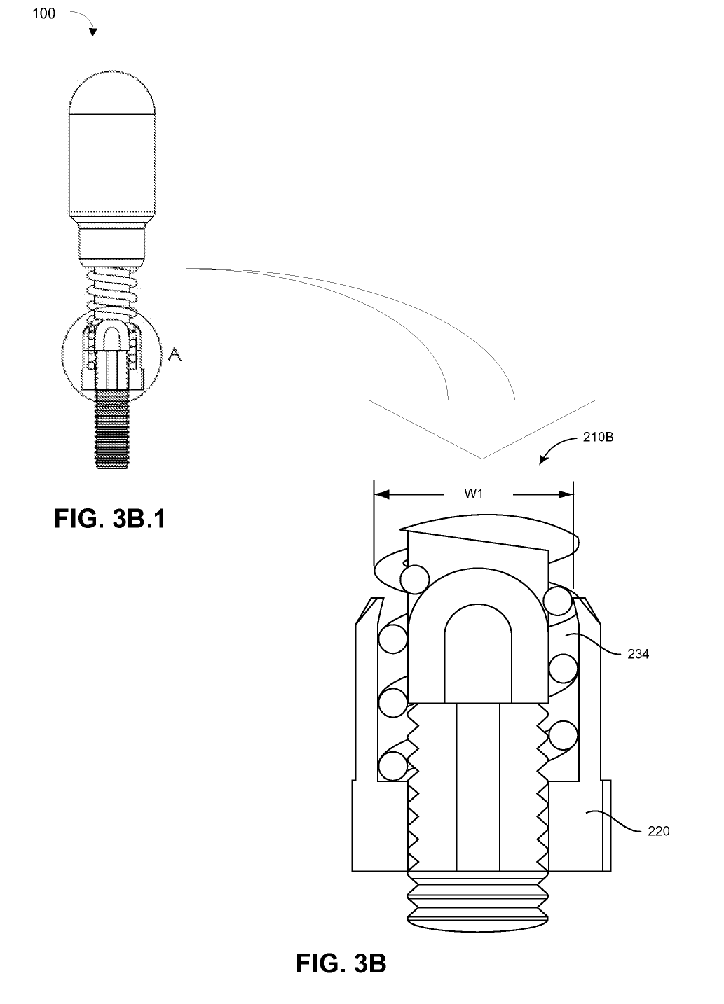

FIG. 3A is a detailed cutaway view of the first end 210A of the flexible shaft 210, in accordance with one embodiment of the present invention. The housing 200 can include a counter bore portion 224 having an inside diameter D1. The inside diameter D1 is substantially equal to a width of the first end 210A of the flexible stalk 210.

The first end 210A of the flexible stalk 210 can be secured in the counter bore 224 by any suitable mechanism. By way of example, the first end 210A of the flexible stalk 210 can be secured in the counter bore portion 224 by an adhesive fill material 226. In another example the first end 210A of the flexible stalk 210 can be secured in the counter bore portion 224 by crimping or otherwise compressing the counter bore portion 224 sufficiently to prevent the first end 210A from being withdrawn from the counter bore portion 224. In another example the first end 210A of the flexible stalk 210 can be secured in the counter bore portion 224 by a threaded fitting such as a threaded sleeve capable of threading into the counter bore portion 224 and capturing the first end 210A in the counter bore portion 224. In another example the first end 210A of the flexible stalk 210 can be secured in the counter bore portion 224 by an adhesive filling material 226 providing a physical bond between the flexible stalk 210 and the counter bore portion 224.

FIG. 3B is a detailed cutaway view of the second end 210B of the flexible shaft 210, in accordance with one embodiment of the present invention. The turn signal mount 220 can include a counter bore portion 234 having an inside diameter D2. The inside diameter D2 is substantially equal to a width of the second end 210B of the flexible stalk 210. The second end 210B of the flexible stalk 210 can be secured in the counter bore portion 234 of the turn signal mount 220 by any suitable mechanism substantially similar to the mechanisms described above.

The turn signal mount 220 is securely coupled to the one or more shaft portions 222. By way of example the one or more shaft portions 222 can be secured to the turn signal mount 220 by an internal thread that engages an external threaded portion of the shaft portions 222. The one or more shaft portions 222 can be secured to the turn signal mount 220 by an adhesive as described above.

The flexible stalk 210 can include a flexible, coiled like, external spring 302. A flexible tube insert 304 has a width W1 substantially equal to an inner diameter of the flexible, coiled like, external spring 302. The flexible tube insert 304 distributes the flexing stress o multiple coils of the flexible, coiled like, external spring 302 to create a more gradual arc of the spring when the flexible stalk is flexed (e.g., in position 112A or 112B).

A minimum engagement of about 1.5 to 2 coils of the flexible, coiled like, external spring 302 are secured in the housing 200 at the first end 210A of the flexible stalk 210. It should be understood that more than about 1.5 to 2 coils of the flexible, coiled like, external spring 302 can be secured in the housing 200.

A minimum engagement of about 1.5 to 2 coils of the flexible, coiled like, external spring 302 are secured in the turn signal mount 220 at the second end 210B of the flexible stalk 210. It should be understood that more than about 1.5 to 2 coils of the flexible, coiled like, external spring 302 can be secured in the turn signal mount 220.

The flexible tube insert 304 can have a length less than the length of the flexible, coiled like, external spring 302 so that when adhesive fill material 226 is injected into the housing 200 and the turn signal mount 220, to secure the respective ends 210A, 210B of the flexible stalk 210, a full “plug” of adhesive can be formed at each end of anchoring engagement. This additional spacing at the ends of the flexible tube insert 304 allows adhesive to “flow” around the coils of the spring and create a solid “plug of adhesive to form at each end of the flexible stalk, thus mechanically anchoring the flexible stalk 210 and resist pull out.

Anchoring the base of the flexible, coiled like, external spring 302 within the counterbore portion 224 allows the non-constrained coils of the spring 302 free to move when shaft 210 is flexed. This prevents coils of the flexible, coiled like, external spring 302 from being permanently deformed by eliminating any fulcrum point of stress where the spring exits the counterbore portion 224.

The flexible, coiled like, external spring 302 size can vary from large to small including having an outer diameter from between about 0.250 inch (about 5.0 mm) to about 2.0 inches (about 50.0 mm) The helical coil pitch of the spring 302 can be constant along the length of the spring 302. Alternatively, the helical coil pitch of the spring 302 can vary along the length of the spring 302. The spring 302 can be partially compressed between the turn signal mount 220 and the light source 204. The spring 302 can be formed having a wire gauge from between about 30 gauge to about 1 gauge.

The flexible stalk 210 can vary in length L1 from less than about 0.5 inches (about 10 mm) to greater than about 5.0 inches (about 80 mm) The flexible stalk 210 can have a diameter D1 of between about 0.250 inch (about 5.0 mm) to about 2.0 inches (about 50.0 mm) The diameter D1 of the flexible stalk 210 can be constant along the length L1. The diameter D1 of the flexible stalk 210 can be variable along the length L1. By way of example, the diameter D1 of the flexible stalk 210 can be greater or less at one or both of the respective ends 210A, 210B of the flexible stalk 210 as compared to the diameter D1 of the flexible stalk 210 in the center portion of the flexible stalk 210 located between the respective ends 210A, 210B.

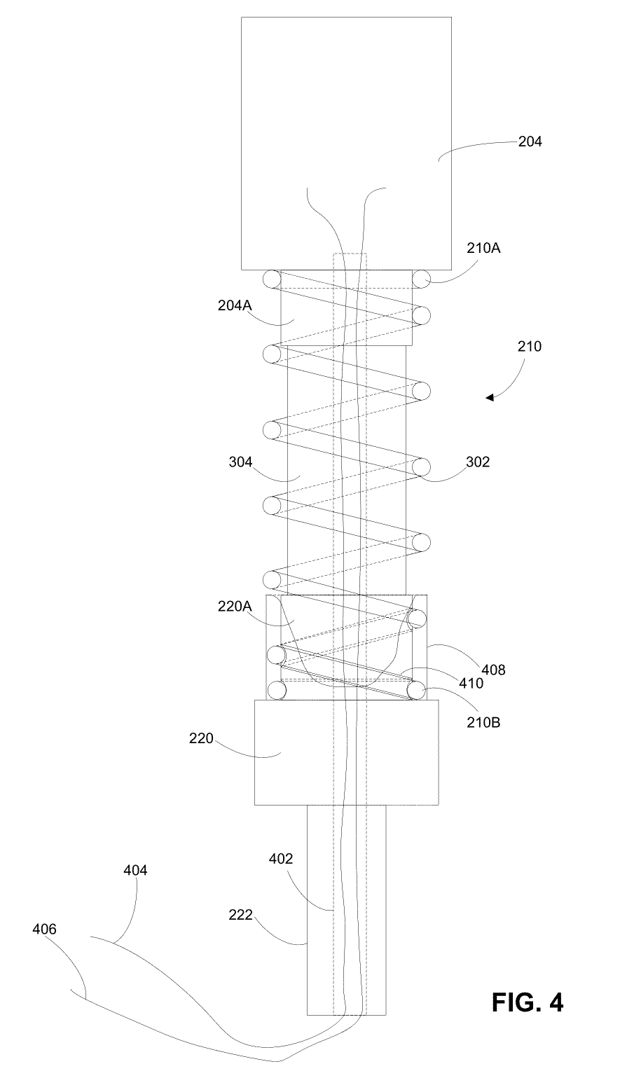

FIG. 4 is a side view of the flexible turn signal 100, in accordance with one embodiment of the present invention. The flexible, coiled like, external spring 302 can also be anchored to an outer diameter portion 220A of the turn signal mount 220 and an outer diameter portion 204A of the light source 204. One or both of the outer diameter portions 204A, 220A may include one or more grooves 410 to correspond to the coils of the spring 302. A band 408 can optionally be placed around one or more coils of the spring 302 providing a clamping pressure on the spring coils to anchor the spring 302 to the outer diameter portions 204A, 220A and in optional the grooves 410.

Also as shown in FIG. 4, one or more electrical conductors 404, 406 can be routed through a inner passage 402 extending through the turn signal mount 220, the flexible tube insert 304 and into the light source 204. It should be understood that while two conductors 404, 406 are show, three or more conductors (e.g. three, four, five or more conductors) could be routed through the inner passage 402. It should also be understood that while the inner passage 402 is shown in the embodiment described in FIG. 4, the inner passage 402 and the electrical conductors can also be present in the embodiments described in FIGS. 1-3A above.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A flexible vehicle signal light comprising:
a turn signal mount;
a light source; and
a flexible stalk including:
a flexible, coiled like, external spring;
a flexible tube insert disposed inside the flexible, coiled like, external spring;
a first end of the flexible stalk secured to the turn signal mount; and
a second end of the flexible stalk secured to the light source.

2. The light of claim 1, wherein at least one of the first end of the flexible stalk or the second end of the flexible stalk are secured inside a respective counter bore portion of the respective light source and the turn signal mount.

3. The light of claim 2, wherein at least a portion of the respective counter bore portion of the respective light source and the turn signal mount is filled with an adhesive fill material including covering at least one coil of the flexible, coiled like, external spring with the adhesive fill material.

4. The light of claim 2, wherein at least a portion of the respective counter bore portion of the respective light source and the turn signal mount is compressed inward to have an inner diameter sufficient to compress an outer diameter of the flexible, coiled like, external spring within the respective counter bore portion.

5. The light of claim 2, wherein the respective counter bore portion of the respective light source and the turn signal mount includes a threaded portion and a threaded sleeve capable of threading into the respective counter bore portion and capturing a respective first end or second end of the flexible stalk in the counter bore portion.

6. The light of claim 1, wherein at least one of the first end of the flexible stalk or the second end of the flexible stalk are secured to a corresponding outer diameter portion of the respective light source and the turn signal mount.

7. The light of claim 6, further comprising a clamping band disposed over one or more coils of the flexible, coiled like, external spring, the clamping band providing a clamping pressure on the one or more coils to clamp the one or more coils to the corresponding outer diameter portion of the respective light source and the turn signal mount.

8. The light of claim 6, further comprising one or more grooves corresponding to one or more coils of the flexible, coiled like, external spring are included in the corresponding outer diameter portion of the respective light source and the turn signal mount.

9. The light of claim 6, wherein at least one of the first end of the flexible stalk or the second end of the flexible stalk are secured to a corresponding outer diameter portion of the respective light source and the turn signal mount with an adhesive fill material.

10. The light of claim 1, wherein the flexible tube insert has an outer diameter substantially equal to an inner diameter of the flexible, coiled like, external spring.

11. The light of claim 1, wherein the light source includes one or more light emitting diodes.

12. The light of claim 1, wherein the flexible stalk further includes an inner passage extending through the turn signal mount, an inner central portion of the flexible stalk and into the light source.

13. The light of claim 1, a plurality of electrical conductors having a first end coupled to the light source and a second end extending beyond the turn signal mount.

14. The light of claim 13, wherein the plurality of electrical conductors are disposed within an inner central portion of the flexible stalk.

15. The light of claim 13, wherein the plurality of electrical conductors are disposed within the flexible tube insert.

16. A flexible vehicle signal light comprising:
a turn signal mount;
a light source; and
a flexible stalk including:
a flexible, coiled like, external spring;
a flexible tube insert disposed inside the flexible, coiled like, external spring;
a first end of the flexible stalk secured to the turn signal mount; and
a second end of the flexible stalk secured to the light source, the flexible stalk further includes an inner passage extending through the turn signal mount, an inner central portion of the flexible stalk and into the light source;
a plurality of electrical conductors having a first end coupled to the light source and a second end extending beyond the turn signal mount, the plurality of electrical conductors passing through the inner passage; and
at least one of the first end of the flexible stalk or the second end of the flexible stalk are secured inside a respective counter bore portion of the respective light source and the turn signal mount, wherein at least a portion of the respective counter bore portion of the respective light source and the turn signal mount is filled with an adhesive fill material including covering at least one coil of the flexible, coiled like, external spring with the adhesive fill material.

17. A flexible vehicle signal light comprising:
a turn signal mount;
a light source; and
a flexible stalk including:
a flexible, coiled like, external spring;
a flexible tube insert disposed inside the flexible, coiled like, external spring;
a first end of the flexible stalk secured to the turn signal mount;
a second end of the flexible stalk secured to the light source; and
wherein at least one of the first end of the flexible stalk or the second end of the flexible stalk are secured inside a respective counter bore portion of the respective light source and the turn signal mount, wherein at least a portion of the respective counter bore portion of the respective light source and the turn signal mount is compressed inward to have an inner diameter sufficient to compress an outer diameter of the flexible, coiled like, external spring within the respective counter bore portion.
